(19) United States
(12) Patent Application Publication
(10) Pub. No.: US 2002/0188480 A1
(43) Pub. Date: Dec. 12, 2002

(54) Insurance risk, price, and enrollment optimizer system and method

(76) Inventors: Michael B. Liebeskind, Pepper Pike, OH (US); Brent Kinetz, New York, NY (US)

Correspondence Address: PILLSBURY WINTHROP LLP, Suite 2800, 725 South Figueroa Street, Los Angeles, CA, 90017-5406, US

(21) Appl. No.: 09/995,852

(22) Filed: Nov. 28, 2001

Related U.S. Application Data
(60) Provisional application No. 60/287,537, filed on Apr. 30, 2001.

(51) Int. Cl. G06F 17/60

(52) U.S. Cl. 705/4

(57) ABSTRACT

A system and method for designing, implementing, enrolling and administering insurance plans that are beneficial for the participant, the plan sponsor, and the insurance carrier(s) are described. According to the invention, an insurance plan is analyzed and characterized. This includes an analysis of the eligible population in view of at least one characteristic, and may also include an analysis of the present state of the insurance plan, method input, external input and method output, and may further comprise past behavior, including the present state of the insurance plan, method input, external input, method output, and/or simulations of future behavior regarding present state of the insurance plan, method input, external input and method output. The result of the analysis is used to determine a positive cycle action which is then applied on the insurance plan. Thereafter the impact on the plan is evaluated.

### PRIORITY DATA

This application claims the benefit of U.S. Provisional Application No. 60/287,537, filed Apr. 30, 2001.

### FIELD OF THE INVENTION

This invention relates in general to insurance plans, and in particular, to a system and method for optimizing the performance of an insurance plan offered to a group of individuals.

### BACKGROUND OF THE INVENTION

Insurance plans offered to a common group of individuals, typically an employee population, are commonplace. This description refers to such plans as “sponsored” plans. Employers, in particular, depend in part on sponsored plans to attract and retain their workforce. Sponsored plans also provide a substantial portion of the insurance protecting the general population from the risk of loss. Clearly, there is a significant need for sponsored plans.

Sponsored plans may be offered to eligible individuals with little or no qualification requirements other than being a member of the sponsoring entity. This description uses the term “simplified issue” plan to describe a type of sponsored plan that includes a process of approving and issuing coverage whereby one or more risk characteristics normally analyzed (or underwritten) are eliminated from consideration in determining an appropriate risk classification and pricing.

An insurance carrier is often engaged to pay claims under the simplified issue plan in return for premium paid by the plan sponsor and/or plan participants. The premium for the insurance is typically based in part on the actual historical claim experience of the particular group of eligible and participating individuals under their simplified issue plan. This type of insurance is referred to in this description as “variable priced insurance”. Certain insurance carriers also issue coverage with a premium schedule that is not based at all on the actual claim experience of the particular group of eligible and participating individuals. This type of insurance is referred to in this description as “fixed price insurance”. Fixed price insurance may be implemented by utilizing individually owned insurance contracts issued by an insurance carrier that guarantees a premium schedule that is not based on the claims experience of the sponsoring entity. In this case, an additional benefit of the fixed price insurance may be that it is portable, meaning that if the individual is terminated from the group, they can maintain the portion of the coverage that is insured with individually owned fixed price insurance policies. However, there is no requirement that fixed price insurance be implemented with individually owned contracts.

An alternative to engaging an insurance carrier to pay claims under a simplified issue plan is for the sponsoring entity to pay the claims directly to the participating claimants or claimants' beneficiaries who qualify for benefits. This description refers to this type of claim paying arrangement as “self-insured”. Plans that are self-insured are, by nature, insured with variable priced insurance because the cost to pay the claims varies based on actual claims experience. It is important to note that this invention applies to simplified issue plans that are either self-insured, carrier insured, or insured with some combination of both.

Simplified issue plans that require participant contributions tend to produce a pool of participants who are more likely to make claims under the plan than the overall eligible population. This phenomenon is referred to in this description as “adverse selection”. Adverse selection is due to the fact that the required participant contribution causes eligible individuals who do not consider themselves at risk of incurring a claim and therefore do not view insurance as a necessity, not to bear the expense and, consequently, not enroll. These individuals tend to present less of a risk of making a claim. They may be younger and healthier. On the other hand, individuals who have health problems and/or suspect they are at risk of needing insurance will very likely enroll. To summarize, insurance plans offered to a group of individuals on a simplified-issue basis that require the participants to pay all or a portion of the cost tend to contain an element of adverse selection.

The presence of adverse selection in a simplified issue plan tends to raise the premium per unit of insurance if the claims are paid with variable priced insurance. This is due to the resulting higher number of claims per participant and tends to promote a negative cycle, since the higher premium per unit of insurance serves as a further disincentive for more healthy individuals who are at a lower risk of becoming claimants to enroll (or remain enrolled) in the plan.

A premium increase may also impact the sponsoring entity negatively. It could cause eligible individuals to think the sponsoring entity is mismanaging the plan and cause them to look more favorably on competing sponsoring entities. Further, if the plan is partially funded and/or self-insured by the sponsoring entity, an increase in claims cost has the additional effect of impacting the entity's financial results during the period preceding the participant premium increase.

Simplified issue plans may also contain the potential for claims volatility. This potential is particularly relevant in plans that insure a small subset of eligible individuals with large benefits since smaller numbers of individuals tend to produce less predictable claim incidence outcomes. It only takes a small variance from the anticipated claims incidence in a small subset of participants with high benefits to result in a large increase over anticipated claims costs. This description uses the term “spiked claims” to describe claim cost volatility due to a significant increase in claims cost over a particular period of time. If variable priced insurance is used to provide coverage for all or a portion of the insurance provided to highly compensated participants, a risk premium will need to be charged in order to protect the insurance provider against the potential impact of such volatility. This description refers to such a risk premium as a “volatility risk premium”. Plans that reduce the potential for volatility should have more predictable claims costs and a correspondingly lower volatility risk premium.

If an insurance carrier insures a simplified issue plan that requires a premium increase due to poor claims experience resulting from the presence of adverse selection spiked claims, the increased premium charged by the carrier may come too late and not be enough to avoid affecting its profitability over some period of time. Even worse for the carrier is when the increased premium triggers an effort by the sponsoring entity, or its representatives, to solicit bids from competitors (a request for proposal or RFP). This process is expensive for the incumbent carrier and can result in the loss of the client. As a result, the profitability to the insurance carrier can lag expectations. In fact, current long-term disability (LTD) industry surveys indicate a lagging return on equity amongst major carriers over the past several years. Accordingly, the current methods of managing LTD insurance plans may not be fully satisfactory, and there is therefore a need to provide improved methods for managing insurance plans.

### SUMMARY OF THE INVENTION

The system and methods disclosed herein address the above-identified problems. In accordance with the system and methods, one or more actions are applied to simplified issue plans over time to optimize their performance in relation to one or more desired criteria. This description refers to these actions as positive cycle actions, since they are intended to set the simplified issue plan on a positive cycle of results for plan participants, plan sponsor(s), and insurance carrier(s).

An object of the invention is to define a method and system of analyzing simplified issue plans in such a way that one or more positive cycle actions can successfully be chosen and implemented to set or maintain the plan on a positive cycle of results.

Another object of the invention is to define a method and system of decreasing the presence of adverse selection in a simplified issue plan.

Another object of the invention is to define a method and system of decreasing the average compensation and/or the standard deviation of the average compensation that is insured by variable priced insurance within the simplified issue plan, and therefore reducing potential claims volatility within the variable priced insurance.

The aforementioned objects, among others, are achieved according to the invention by applying a method and a system of designing, implementing, enrolling and administering insurance plans, such as simplified issue insurance plans, that is beneficial for the participant, the plan sponsor, and the insurance carrier(s). According to the invention, an insurance plan is analyzed and characterized. This includes an analysis of the eligible, participating and non-participating, population of potential insureds with respect to at least one characteristic. The analysis may also include a study of the present state and structure of the plan, method input, external input, and method output. The analysis may further incorporate past behavior data, both from the participants and non-participants, and past behavior data from outside the plan that may have predictive value with respect to the plan. This data may then be used to produce simulations of potential future behavior of the present plan, method input, external input, and method output. The result of the analysis is used to determine at least one action, such as a positive cycle action described below, which may be applied to the plan. After application of the chosen action or actions, the impact on the plan is suitably evaluated. Ideally, the evaluation will lead to further actions, either directly or after further analysis of the eligible population. It should also be noted that several of these actions may overlap and could be seen as sub-actions of one another in certain circumstances.

The instant invention is also directed to a method of optimizing a performance of a simplified issue plan. The method comprises a number of steps. In a first step, at least one characteristic of the participating population and/or non-participating population is analyzed in relation to the eligible population. Then, in a second step, one or more positive cycle actions are determined based on the analysis. In a third step the selected positive cycle action or actions are applied. Then suitably in an optional step the impact of the applied positive cycle action or actions is evaluated. The optional step of evaluation is not necessarily performed simultaneously for all applied positive cycle actions if more than one positive cycle action is applied. The method can be repeated, either directly or after an additional positive cycle action or actions have been applied, based on the evaluation. In some versions of the method, several cycles of steps one (1) through four (4) can be run concurrently. The lead-time of the different cycles may be different, such that, eventually, if the process is repeated, two or more different cycles may run in an overlapping manner.

One positive cycle action is an action that increases enrollment. This description refers to such an action as an increase enrollment action. The increase enrollment action may be targeted to specific groups within the eligible population based on the step of analyzing the eligible population. These specific groups may be selected in order to reduce an element of adverse selection, which is referred to as a reduce adverse selection action. In such a case, the step of analyzing the population is comprised of analyzing a characteristic or a number of characteristics of the non-participating individuals in relation to the participating individuals that may help to determine their respective probabilities of incurring claim costs. The increase enrollment action and the reduce adverse selection action may include a process of generating promotional information and various processes to facilitate enrollment that are tailored to the targeted groups.

In some versions of this positive cycle action, all or a portion of the benefits for all or a portion of the participants may become portable as a result of a shift risk action (described below). This may mean that if a particular participant were to be terminated from the group of eligible individuals, that participant would be able to maintain that portion of his/her benefit that is portable. This is generally seen as an enhancement to the plan and a further incentive to participate. This action is referred to in this description as a “portability action”. In some versions of this positive cycle action, the price to participants is decreased (referred to in this description as a “decrease participant price action”). In other versions, the price to participants may be segmented such that the targeted group or groups are encouraged to enroll (referred to in this description as a “segment participant price action”). This segmentation may result in price decreases to some or all participant segments or price decreases to certain participant segments and increases to other participant segments. These variations may include the step of analyzing the eligible population and relevant data in order to determine appropriate pricing segmentation.

Typically, the analysis includes a study of one or more population characteristics, which may be segmented and may include, but are not limited to: location; gender; plan options; job description; business unit or division; price (e.g., participant rate for insurance); title; previous method of communication; current method of communication; future method of communication; age; compensation; employer contribution; taxability of benefit; benefit formula; benefit maximum; level and structure of fixed price insurance; level and structure of variable priced insurance, smoker status; years employed; training and/or education; various other risk characteristics; Standard Industrial Classification (SIC) code of plan sponsor; etc. It is important to note that this analysis may include studying non-plan related behavior characteristics of non-participants and participants that may be indicative of participation behavior and/or potential claims incidence. In any event, the increase enrollment action will seek to clearly communicate the benefits of the plan, which may include reduced price, increased portability, or other improved benefits, along with providing a simple means of enrolling, in order to enhance participation.

Simplified issue plans are typically comprised, in whole or in part, of variable priced insurance. One positive cycle action is an action that, after impact, will reduce the average benefit per participant and/or will reduce the standard deviation of average risk per participant that is insured with variable priced insurance. The resulting reduction in variable insurance benefits and their potential volatility will reduce the volatility risk premium and create a positive economic effect that can enable further positive cycle action(s). By itself, this positive cycle action is referred to in this description as a reduce group claims volatility action. One example of a further positive cycle action may be an action that reduces the variable priced insurance by adding or increasing fixed price insurance, therefore maintaining existing benefit levels. This positive cycle action may result in the use of fixed price insurance to provide all or a portion of the insurance covering all or a portion of the participants. This positive cycle action is referred to in this description as the shift risk action. Fixed price insurance may be implemented by utilizing individually owned insurance contracts issued by an insurance carrier that guarantees a premium schedule that is not based on the claims experience of the group. In this case, an additional benefit of the fixed price insurance may be that it is portable, meaning that if the individual is terminated from the group, they can maintain the portion of the coverage that is insured with individually owned fixed price insurance policies. However, there is no requirement that fixed price insurance be implemented with individually owned contracts.

An additional positive cycle action, referred to in this description as a request for proposal action, is an action that uses the results of the analysis in a request for competitive pricing from the marketplace of insurance carriers willing to pay claims under a simplified issue plan. This action is comprised of summarizing the results of the analysis, the other positive cycle actions that have been implemented, and the design of the simplified issue plan in order to enable the carriers to most accurately assess the potential cost of insuring the plan. This action often results in a reduced price to insure the plan.

The method may further comprise an additional three steps. The first additional step is determining one or more additional positive cycle actions based on the evaluation of the impact of the applied positive cycle action. The second additional step is applying the determined additional positive cycle action. The third additional step is evaluating the impact of the applied additional positive cycle action. The additional positive cycle action could include one or more of, but is not limited to, the following: a request for proposal action, an increase enrollment action, a reduce adverse selection action, a reduce group claims volatility action, a shift risk action, a portability action, a decrease price action, and/or a segment price action.

In some versions of the invention, the method further comprises the step of importing past claims experience of the eligible population, or a population similar to the eligible population, and utilizing the predictive results of an analysis of the imported data to help determine one or more positive cycle actions to be taken. In another variation, the method may be further comprised of the step of importing other data that correlates to the eligible population, the participants, or the non-participants, and utilizing the predictive results of an analysis of the imported data to help determine one or more positive cycle actions to be taken.

The instant invention is also related to a method of optimizing a performance of a simplified issue plan to an eligible population. The method comprises a number of steps. In a first step, the eligible population is analyzed in view of at least one characteristic of the eligible population in relation to the simplified issue plan. In a second step, at least one positive cycle action is determined based on the analysis, and finally, a third step applies the determined positive cycle action or actions. The method can suitably further comprise the step of evaluating an impact of the applied positive cycle action or actions. In some versions, the step of analyzing the eligible population in view of at least one characteristic of the eligible population comprises analyzing the eligible population in view of at least one characteristic of the eligible population in relation to the participants of the simplified issue plan. Sometimes, the step of determining at least one positive cycle action based on the analysis comprises determining at least one parameter of at least one determined positive cycle action. Preferably at least one characteristic of the eligible population is a characteristic that impacts overall plan performance. A positive cycle action can suitably be a request for proposal action, an increase enrollment action, a reduce adverse selection action, a reduce group claims volatility action, a shift risk action, a portability action, a decrease price action, and/or a segment price action.

If the positive cycle action is a shift risk action, then the simplified issue plan is modified to include an element of fixed price insurance such that at least some participants are at least partly insured with the fixed price insurance in accordance with the shift risk action. The simplified issue plan can suitably be modified such that: (1) all eligible participants receive a portion of their benefit through fixed price insurance; (2) all eligible participants receive an increased portion of their benefit through additional fixed price insurance; (3) selected eligible participants (i.e., eligible participants who meet specified criteria, such as, e.g., earning over a set income limit) receive all or a portion of their benefit through fixed price insurance; or (4) selected eligible participants (i.e., eligible participants who meet specified criteria, such as, e.g., earning over a set income limit) receive an increased portion of their benefit through additional fixed price insurance. In all cases, the fixed price insurance added to the benefit may either replace variable priced insurance resulting in the maintenance of the same total benefits for each participant, or add to variable priced insurance resulting in the increase of total benefits for selected participants. It is noted that the term “eligible participants” is used here since there may be situations where certain participants may not be eligible for fixed price insurance (e.g., due to age restrictions).

The step of analyzing the population can suitably comprise analyzing the eligible population in view of one or more of location of work, location of home, gender, plan options, job description, business unit division, price, title, previous or current method of communication, age, compensation, employer contribution level, tax-status, benefit formula, benefit maximum, various risk characteristics, smoker status, correlation of participation characteristics of other plans within group, and/or correlation with behavior characteristics not related to the group.

The method can suitably further comprise the additional steps of determining a further positive cycle action based on the evaluation of the impact of the applied positive cycle action, applying the determined further positive cycle action, and evaluating an impact of the applied further positive cycle action. A further positive cycle action can preferably be one or more of a request for proposal action, an increase enrollment action, a reduce adverse selection action, a reduce group claims volatility action, a shift risk action, a portability action, a decrease price action, and/or a segment price action. The method suitably further comprises the step of importing past experience of the eligible population at hand, or of at least a similar population and the step of determining at least one positive cycle action based on the analysis.

The instant invention is also directed to a system that is configured to optimize the performance of a simplified issue plan to an eligible population. The system is comprised of analyzing means, determining means, applying means, and evaluating means. The analyzing means is configured to analyze the participating or non-participating population in view of at least one characteristic of the participating or non-participating population in relation to the eligible population within the simplified issue plan. The determining means is configured to determine a positive cycle action based on the analysis. The applying means is configured to apply the determined positive cycle action. The evaluating means step is arranged to evaluate an impact of the applied positive cycle action. According to the invention, one or more improvements of the method according to the invention as described above can be incorporated into the system according to the invention, as long as no conflict occurs.

Simplified issue plans typically contain the potential for significant claims volatility. This potential occurs most significantly when plans have high benefit limits for a small subset of eligible individuals. For example, disability plans typically insure a percentage of income and employers typically have a relatively small percentage of employees with earnings that are significantly higher than the average employee income. Therefore, a disability plan sponsored by an employer may have relatively few individuals with high insurance benefit amounts. Insurance, in general, depends on the predictability of claims. The predictability of claims costs is improved when the number of insureds is larger. In the example above, the highly compensated participating individuals may experience a higher degree of volatility in both claims incidence and claims cost than should be expected from the lower compensated individuals. This description uses the term spiked claims to describe an event where such volatility happens to result in a significant increase in claims cost over a particular period of time. If variable priced insurance is used to provide coverage for all or a portion of the insurance provided to highly compensated participants, a risk premium will need to be charged in order to protect the insurance provider against the potential impact of such volatility. This description refers to such a risk premium as a volatility risk premium. Plans that reduce the potential for volatility should have more predictable claims costs and a correspondingly lower volatility risk premium.

The present invention addresses the issues raised above through a system and methods of designing, implementing, enrolling, and administering simplified issue plans that are beneficial for the participant, the plan sponsor, and the insurance carrier(s). The features and advantages of the present invention will be explored more thoroughly through the following description and drawings. It should be understood, however, that the detailed description and specific examples, while indicating particular embodiments of the invention, are given by way of illustration only, and various modifications may naturally be performed without deviating from the spirit of the present invention.

### BRIEF DESCRIPTION OF TIE DRAWINGS

The present invention can be understood more completely by reading the following detailed description of exemplary embodiments, in conjunction with the accompanying drawings, in which:

FIG. 1 shows a flowchart of a basic method of optimizing an insurance plan according to an embodiment of the invention.

FIG. 2 shows a flowchart of an enhanced process of optimizing an insurance plan according to an embodiment of the invention.

FIG. 3 shows employee distribution in relation to compensation.

FIG. 4 shows a price-participation demand curve.

FIG. 5 shows a relationship between adverse selection density and participation level.

FIG. 6 shows a relationship between claims incidence and participation levels.

FIG. 7 shows the potential impact of decreasing cost on a positive cycle.

FIG. 8 shows a flat top shift risk action.

FIG. 9 shows a split top shift risk action.

FIG. 10 shows an example of a study of a compensation distribution function and its impact on variable priced insurance.

FIG. 11 shows the impact of a shift risk action on the study exemplified in FIG. 10.

FIG. 12 shows a system model according to an embodiment of the invention.

### DETAILED DESCRIPTION

The present invention deals with insurance plans and, more specifically, with simplified issue plans. Simplified issue plans are insurance plans, as defined in the above summary, made available to a predetermined group of people, referred to herein as an eligible population. A typical example of an eligible population is a group of individuals employed by the same company. As previously discussed, there are inefficiencies within simplified issue plans that threaten the stability of these plans over time. The present invention provides a method of infusing gradual improvements into a simplified issue plan, thereby creating and maintaining a positive cycle of improved results. This is accomplished according to the invention by first analyzing the eligible population in view of at least one characteristic, and then utilizing the outcome of this analysis to determine one or more positive cycle actions to improve plan performance. The analyzed characteristic(s) of the eligible population may include, but are not limited to, one or more of the following:

Location of work;

Location of home;

Gender;

Plan options;

Job description;

Business unit or division;

Price;

Title;

Previous method of communication (e.g., from plan sponsor or administrator to an eligible population and/or to eligible employees);

Current method of communication;

Future method of communication;

Age;

Compensation;

Employer contribution;

Taxability of benefit;

Benefit formula;

Benefit maximum;

Level and structure of fixed price insurance,

Level and structure of variable priced insurance;

Smoker status;

Years employed;

Training and/or education;

Various other risk characteristics;

SIC code of plan sponsor;

Participation in the plan; and

Existing participation levels in view of characteristics that may include, but are not limited to, one or more of the following:

Location of work;

Location of home;

Gender;

Plan options;

Job description;

Business unit or division;

Price (e.g., participant rate for insurance);

Title;

Previous method of communication;

Current method of communication;

Future method of communication;

Age;

Compensation;

Employer contribution;

Taxability of benefit;

Benefit formula;

Benefit maximum;

Level and structure of fixed price insurance

Level and structure of variable priced insurance;

Smoker status;

Years employed;

Training and/or education;

Various other risk characteristics;

SIC code of plan sponsor; and

Participation in the plan;

It is important to note that this analysis may include studying non-plan behavior characteristics of non-participants and participants that may be indicative of participation behavior or potential claims incidence and help determine appropriate positive cycle action(s).

Resulting positive cycle actions may include, but are not limited to, an increase enrollment action, a shift risk action, a decrease participant price action, segment participant price action and/or a request for proposal action. The function and implementation of the various positive cycle actions will be further described below.

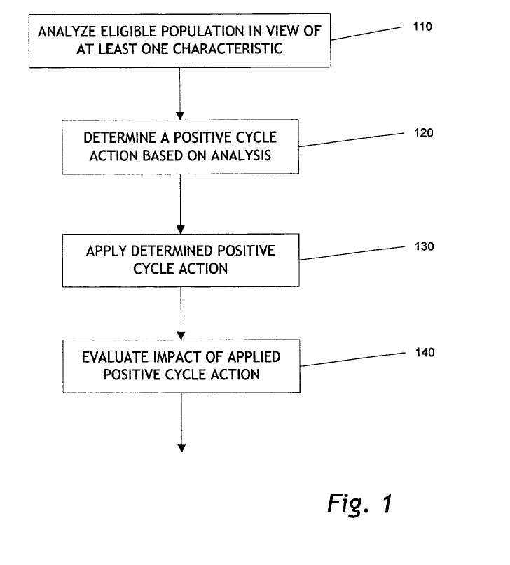

FIG. 1 shows a flowchart of a basic method of optimizing a simplified issue plan according to the invention. In a first step 110, an eligible population is analyzed in view of at least one characteristic, examples of which are described above. In a second step 120, after the first step 110, the appropriate positive cycle action (or actions) is determined based on the analysis, examples of which are described above. Thereafter, in a third step 130, the determined positive cycle action is applied. Then, preferably, in a fourth step 140, the impact (or impacts) of the applied positive cycle action (or actions) is evaluated after an appropriate timeframe has elapsed from the application of the action (or actions).

The full impact of certain positive cycle actions might emerge over the course of a year or more, while other positive cycle actions might have an almost immediate impact. A very important aspect of the invention is that a positive cycle action is determined based on an analysis that is made on all or a portion of the eligible population in view of one or more characteristics. Further cycles of positive cycle actions may then be appropriately applied either directly based on the evaluation, the original analysis, or after performing a further analysis of all or a portion of the eligible population. In some versions, it may be suitable to have several positive cycle actions running simultaneously. Therefore, it must be noted that the appropriate timeframe for evaluating the impact(s) of the different cycles of positive cycle action(s) may vary. Examples of different positive cycle actions and the criteria by which they are determined will be further discussed below.

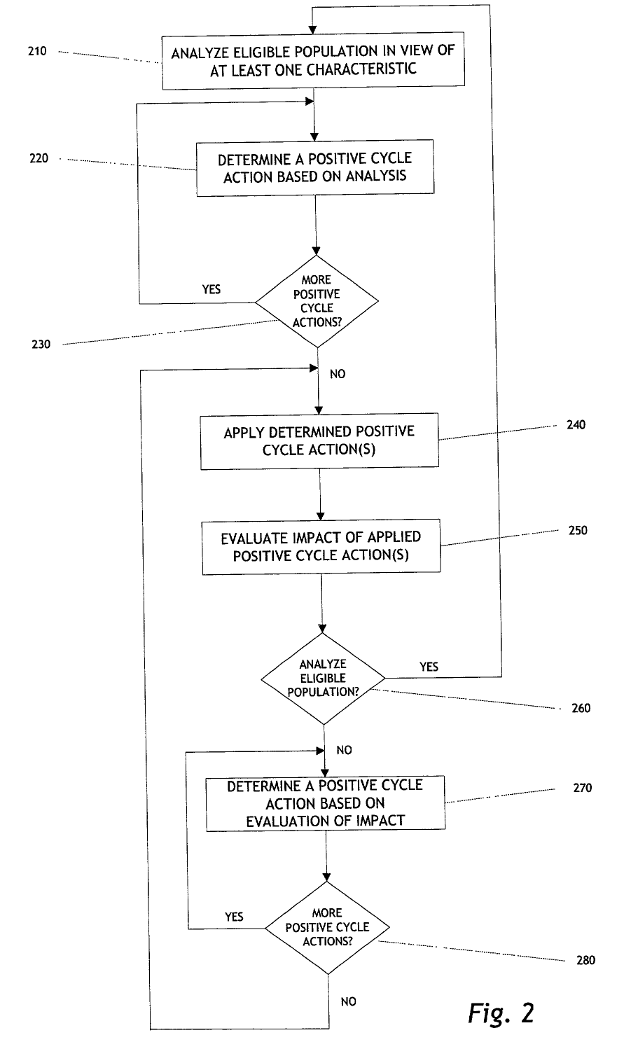

FIG. 2 shows a flowchart of an enhanced process of optimizing an insurance plan according to the invention. In a first step 210, an eligible population of the simplified issue plan to be optimized is analyzed in view of at least one characteristic. As described previously, an analyzed characteristic may be compensation (e.g., determine how many individuals in the eligible population earn more than $200,000 per year). After the analysis, a second step 220 determines an appropriate positive cycle action based on the analysis. Assuming the plan has high benefit limits that correspond to compensation, and further assuming that 100% of the plan is insured with variable priced insurance, an appropriate positive cycle action may be a shift risk action. If this action is applied in a fashion that transfers a portion of the insurance covering highly compensated individuals from variable priced insurance to fixed price insurance, the potential for volatility within the variable priced insurance will be decreased. As discussed earlier, this should cause the price per unit of benefit for the variable priced insurance to decrease.

Then, in a third step 230, it is determined if more positive cycle actions should be applied, and if so, the second step 220, is repeated. For example, the analysis may reveal a below-average participation rate amongst individuals with compensation in excess of $200,000. Highly compensated individuals are usually a segment amongst whom an employer wants to maintain a high level of benefits satisfaction. Satisfaction with a benefit plan is often measured by how many eligible individuals participate. In addition, highly compensated individuals are often viewed as leaders by other employees, so an increase in participation among highly compensated individuals often leads to an increase in participation throughout other segments of the employee population. Accordingly, the second positive cycle action could be an increase enrollment action targeting this group of highly compensated employees. Using the example above, the increase enrollment action would focus on the added feature of portability resulting from the shift risk action when communicating with those whose compensation exceeds $200,000.

After a positive cycle action (or actions) has been determined, a fourth step 240 is initiated wherein the determined positive cycle action (or actions) is applied. In the example above, a shift risk action and an increase enrollment action will be implemented. First, in order to apply the shift risk action, the simplified issue plan may be restructured so that all or a portion of certain claims incurred after a specific date (the effective date) are paid by a combination of variable priced insurance and fixed price insurance. Then, during a period generally proceeding the effective date of the restructuring, a communication and enrollment period will occur (the open enrollment). It is during this period that the increase enrollment action is applied.

After an appropriate amount of time has elapsed since the application of the positive cycle action or actions, a fifth step 250 evaluates an impact of the applied positive cycle action or actions. Based on the example above, the evaluation might show that the shift risk action has decreased the volatility in claim costs insured by variable priced insurance as a result of the reduced average insurance compensation level and standard deviation thereof, and further, the increase enrollment action has increased the participation and thereby reduced the claims incidence as a percentage of the overall population due to a reduction in adverse selection. Then, in a sixth step 260, it is determined if the eligible population should be analyzed again in view of at least one characteristic before any further positive cycle actions are determined.

If it is determined that the eligible population needs to be analyzed before any further positive cycle actions are determined, then the process is continued with the first step 210. Alternatively, if it is determined that no more analysis needs to be done before determining further positive cycle actions then the process continues with a seventh step 270.

The seventh step 270 determines a positive cycle action based on the evaluation of an impact of the already applied positive cycle action or actions. Following the example above, the determined positive cycle action might be a decrease participant price action as a result of the decreased claim costs experienced by the plan. Thereafter in an eighth step 280, it is determined if additional positive cycle actions should also be determined, and if so, repeat the seventh step 270. Continuing with the example above, a request for proposal action may be determined in order to ensure the most competitive price from insurance carriers given the reduced claim costs, the reduced potential for claim volatility, and the reduced presence of adverse selection as noted above. Then, the process continues with repeating the fourth step 240 of applying the newly chosen positive cycle action or actions. The process of optimizing the simplified issue plan thus continues.

In order to fully analyze and optimize the highly complex environment of insurance plans, the following models may be defined. The described models are only one possible representation of the actual environment; there are other models that could describe the invention equally well and lead to the same or similar conclusions.

The models describe an approach to analyzing a simplified issue plan where the insurance benefit correlates to a participant's compensation. A disability insurance plan that provides income replacement in the event a participant's compensation is reduced or terminated due to a disabling accident or sickness is an example of this type of plan. Again, this type of plan is only one possible representation of the type of insurance plans that could benefit from this invention. Also, the formulas included in this description are based on a one-year period in order to facilitate a general understanding of the method. It will be apparent to the person skilled in the art that the formulas can easily be expanded to comprise several years' projections and/or year-to-year variations of all variables.

Simplified issue plans requiring contributions from the participants typically do not appropriately address the risk of adverse selection. Since enrollment in participant-funded plans is voluntary and typically requires a positive election to enroll in the plan, the eligible participants must receive an offer from a sponsoring entity, review and understand the offer, then respond positively within a specified period of time in order to participate. Insurance plans are often complex and require an investment of time and energy on behalf of the buyer, in addition to a willingness to pay premiums, before an election to participate is made. A plan sponsor is often not skilled at communicating the features, the costs, and the benefits of insurance plans and may present information about the opportunity to enroll in a fashion that is difficult and/or time consuming to understand. In addition, the data analysis of the eligible individuals that may be performed may not identify pockets of low participation and may not be used to develop tailored communications targeted specifically to these segments of the population. The complexity of the current enrollment process, the lack of data analysis, and the required participant funding, combine to increase adverse selection risk.

The instant invention provides a simplified issue plan sponsor, or the sponsor's plan administrator, with proven communication and enrollment methods that accomplish the objective of increasing enrollment (see below for an example relating to a communication module).

If the simplified issue plan is insured, the insurance carrier makes an estimation of anticipated participation and charges a corresponding adverse selection load. This load might not be itemized in a carrier's premium quote, but is nonetheless present. In general, the lower the participation anticipated, the higher the adverse selection load, and the higher the corresponding total carrier premium required. The adverse selection load compensates the carrier for the expected higher-than-average claim incidence among participants. For example, if participation is less than 100%, the incidence of disability per participant will be higher than the incidence of disability within the overall eligible population.

The negative impact of adverse selection can be significantly reduced if a higher percentage of eligible individuals become enrolled in the simplified issue plan. Generally, each new participant or group of participants added to the plan represents a lower risk than the existing participants. This is due to the tendency of individuals least likely to make a claim to be the most reluctant and the last to enroll in the plan. As a result, in a period following a successful increase enrollment action, the percentage of participants who will make claims should decrease. Therefore, as enrollment increases, the claim costs per unit of benefit should decrease. Over time, the lower claim cost, if passed on to participants in the form of premium reductions or benefit enhancements, should serve to increase participation in the plan. This is a positive cycle according to the invention.

Often, a simplified issue plan will cover different participants at different levels. For instance, a disability plan typically covers a percentage of a participant's compensation. The higher the compensation, the higher the potential benefit to the participant and cost to the insurer. When an eligible population is comprised of individuals with a broad range of earnings, a potential volatility of claims is possible. In other words, the per capita incidence of disability can stay level from period to period, but the cost will vary depending on which participants become disabled. Most eligible populations are comprised of a relatively small number of highly-compensated individuals and a broad base of non-highly compensated individuals. This population demographic creates volatility risk. In general, the greater the discrepancy in earnings amongst participants, the greater the volatility risk. If an insurance carrier is engaged to insure claim costs for a sponsoring entity where such a discrepancy exists, they will charge a volatility risk load. In one embodiment, this invention helps reduce the volatility risk load using the shift risk positive cycle action described below.

Traditionally, simplified issue plans utilize experience-based variable priced insurance to pay claims. However, when an insurance plan is of a type where the plan sponsor is willing to consider offering fixed price insurance in addition to the variable priced insurance, this invention creates an opportunity to introduce an element of fixed price insurance into the plan. This is referred to as a shift risk action. By implementing a shift risk action, the impact of a portion of the claims volatility is transferred from the plan's experienced-based variable priced insurance to the insurance carrier offering the fixed price insurance. To the extent that the variable priced insurance can be reduced or replaced with fixed price insurance, the volatility risk load should be reduced, as should the cost per unit of the variable priced insurance benefit be driven down. Additionally, fixed price insurance may be portable, which enables a participant to maintain the coverage even if they cease to be a member of the plan's eligible population. Variable priced insurance is typically not portable. Coverage portability, if properly communicated, should have a high degree of perceived value by the eligible population. The higher-perceived value, possibly combined with a decrease participant pricing action, a segment participant pricing action, or other positive cycle action according to the invention resulting from the reduced volatility load, may be highly beneficial to the plan since it may have the impact of further increasing enrollment and further reducing adverse selection. A positive cycle is thus continued.

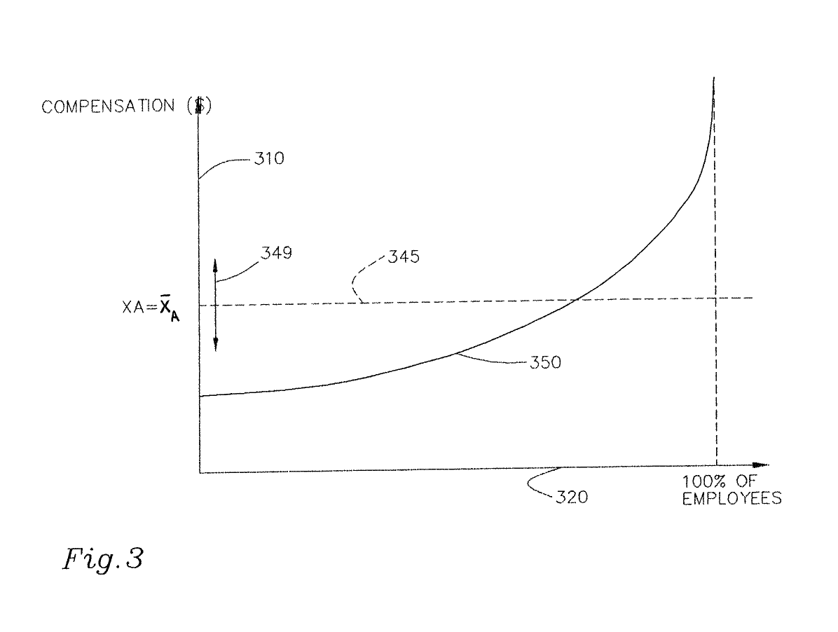

FIG. 3 illustrates a model that analyzes employee distribution 350 based on compensation (typically salary, bonus, and/or other benefits). The X-axis 320 represents the density of different compensation groups within an employee population. Compensation, represented along the Y-axis 310, is often the most significant parameter in defining the costs and benefits of certain simplified issue plans such as disability plans. Also, the premium cost per unit of benefit charged to an individual is often correlated to, and segmented by, compensation. Other factors that could be taken into account for disability insurance (as well as other types of insurance) include, but are not limited to, the following: location; gender; plan options; job description; business unit or division; price; title; previous method of communication; current method of communication; future method of communication; age; compensation; employer contribution; taxability of benefit; benefit formula; benefit maximum; level and structure of fixed price insurance; level and structure of variable priced insurance; smoker status; years employed; training and/or education; various other risk characteristics; SIC code of plan sponsor; etc.

The calculation in FIG. 3, and this description in general, assume even distribution of participants between each compensation segment in order to facilitate general understanding of the method. However, plans typically have uneven participation, which means that participation, as a percentage of the total eligible population for a given compensation segment, varies from compensation segment to compensation segment. The plan results may be further optimized when taking into account uneven participation. For example, uneven participation may be addressed by implementing the increase enrollment action. Uneven participation may also be a factor in determining the most advantageous implementation of the shift risk action and its anticipated results. Further, uneven participation analysis provides data that is helpful to the variable priced insurance carrier when determining appropriate pricing and in particular, the adverse selection and volatility risk loads. These parameters may be weighted together and represented in FIG. 3 as an average 345 and standard deviation 349. In FIG. 3, the Average Compensation (XA) 345 and the Standard Deviation thereof (SIGA) 349 are represented. The unit for compensation is USD (capped at the maximum insured earnings covered) and the X-axis 320 is normalized from 0-100% of the population. If the entire eligible population participated in the plan, and the plan were entirely insured with variable priced insurance, the average claim per insured in a given year (i), could be estimated as follows:

Claims(average)(i)/insured=ReplRatio*XA*Pdb(i)

The income replacement ratio (ReplRatio) is the factor that, when applied to insured compensation, results in the total benefit for the individual claimant. The calculation assumes that all individuals are being offered the same ReplRatio, but can easily be expanded to take into account multiple ReplRatios. Pdb is the average probability that an individual insured within the overall insured population makes a qualifying claim. This leads to the formula that defines required insurance pricing to cover the claims for year (i), illustrated as follows:

Price(average)(i)/Insured=Claim(average)(i)*(1+3rdPrtyCost)

3rdPrtyCost represents a factor to pay an insurance carrier's and/or administrator's operational costs, profit margins and other applicable costs. The equation could be expanded to:

Price(average)(i)/Insured=ReplRatio*XA*Pdb(i)*(1+3rdPrtyCost)

The Price(average)(i)/Insured above is not complete because it does not comprise any additional premium load (RiskPrem) to cover the additional risk in the plan. Additional risk can result from several factors, including:

Potential volatility of claims cost due to a high standard deviation of average claims (SIGA). This can be referred to as volatility risk load.

Low participation in the plan, resulting in adverse selection or the fact that eligible individuals who are at a high risk to make claims tend to be among the first to participate. Low participation drives up Pdb amongst participants. ParticipationLev is being used to define the percentage of eligible individuals who participate in the insurance benefit. This is referred to as adverse selection risk load.

Pdb uncertainty as a result of the difficulty of precisely anticipating participation levels.

Therefore, the Price(average)(i)/Insured for variable priced insurance must be expanded as follows:

Price(Average)(RiskPrem)(i)/Insured=ReplRatio*XA*SecPx*Pdb(i)* (1+3rdPrtyCost)

The security premium (SecPx) is a factor that should be applied to the projected anticipated claim cost in order to properly price for additional risks in the plan as described above. The result is that the average participant price will include a premium load reflecting SecPx. Factors in determining SecPx include, but are not limited to, the following:

SecPx—where SecPx is an adjustment factor based on business SIC, geographic region, etc.;

SecPx=(XA+SIGA)/XA;

SecPx=C-ParticipationLev, where C, for example, is 2;

SecPx is based on historical calculations;

SecPx=(XA+SIGA)*(1+|P′db(x)|)/XA;

SecPx=XA+Other Factor; or

SecPx=XA*OtherFactor.

The size of required SecPx may vary depending upon how well the insured population, and its inherent risks, can be defined. SIGA is a natural component of claims volatility, reflecting that the claim level may vary within the various segments of the participating population. Participation levels are a natural component of adverse selection.

In summary, variables affecting the average participant price, including the risk premium per participant, are as follows:

XA=Average compensation;

SIGA=Standard deviation of average compensation (for claim amount volatility);

Pdb=Average probability of claims being made;

P′db=Sensitivity of additional participants;

SecPx=Security premium, carrier charge adjustment factor to protect against extra risk;

3rdPrtyCost=Factor to pay carrier or third party administrator's operational costs, profit margins, and/or other costs.

According to the invention, by reducing one or more of these factors, the average price for the variable priced insurance should decrease, which would help to drive a positive cycle according to the invention.

In economics, the demand curve is a graphic representation of the relationship between product price and the quantity of the product demanded. It is drawn with price on the Y-axis of the graph and quantity demanded on the X-axis. With few exceptions, the demand curve is delineated as sloping downward from left to right because price and quantity demanded are inversely related (i.e., the lower the price of a product, the higher the demand or number of sales). This relationship is contingent on certain conditions remaining constant. Such conditions include the number of consumers in the market, consumer tastes or preferences, prices of substitute goods, consumer price expectations, and personal income. A change in one or more of these conditions causes a change in demand, which is reflected by a shift in the location of the demand curve. A shift to the left indicates a decrease in demand, while a movement to the right indicates an increase in demand.

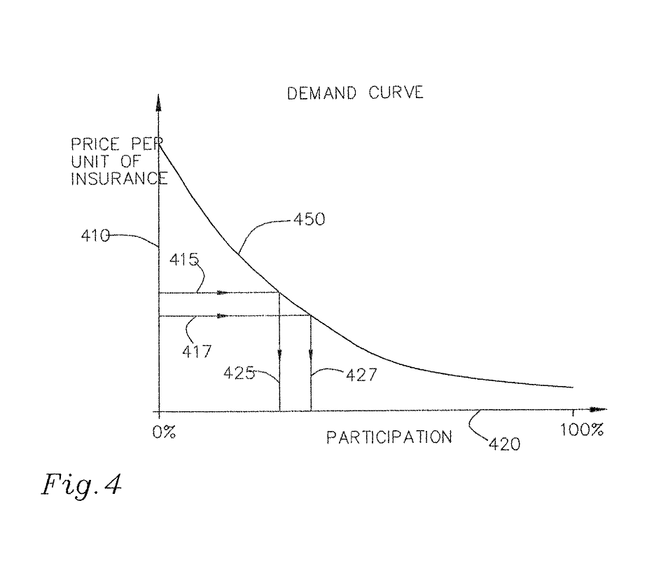

In order to predict what will happen to participation if the average premium charged to participants for the insurance is decreased, a demand curve must be introduced into the model. FIG. 4 illustrates how a demand curve 450 could look for a simplified issue plan within a given population of eligible individuals, where the Y-axis 410 is the price per unit of insurance and the X-axis 420 is the participation level. A price level 415 can be intersected with a demand curve 450 that will theoretically predict the number of eligible individuals who will elect to participate 425 in the plan. The demand curve 450 indicates that more individuals 427 will enroll in the plan if the price is lowered 417. The characteristics of the estimated compensation distribution, demand curve, and Pdb distribution will have an impact on which positive cycle action according to the invention shall be applied first and in which order the various positive cycle actions according to the invention are applied.

The economic theory of adverse selection was developed to explain how competitive insurance markets would behave when buyers have more information about their likelihood of needing to make an insurance claim than an insurer. When insurers are willing to offer contracts that may be profitable, a process of self selection may occur whereby the people who think they will need the insurance purchase the contracts and the people who don't think they will need the insurance do not purchase it. When one party in a transaction knows more about a relevant fact or facts about the goods, or in this case the insured, this is called asymmetric information or hidden value. This is the key to adverse selection.

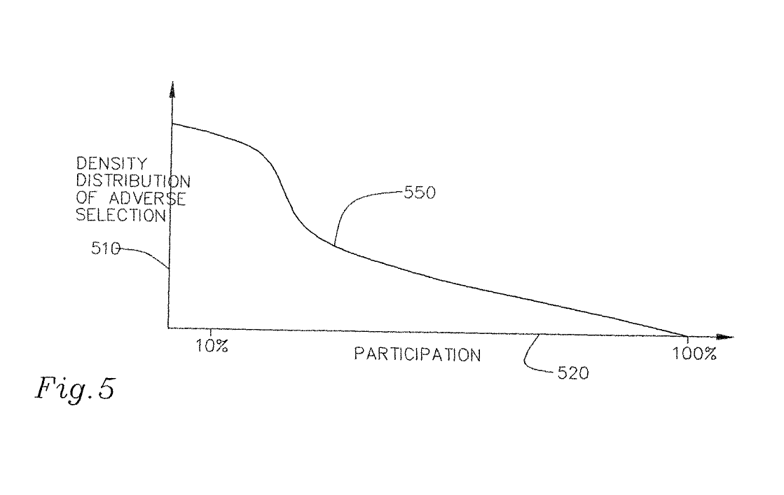

FIG. 5 illustrates the density function 550 of adverse selection 510 correlation to participation 520. It indicates, in combination with FIG. 4, a high propensity amongst a certain segment of the population represented on the far left of the curve 550, to pay for insurance in spite of high prices. This segment is made up of individuals potentially more likely to result in a claim and is correlated to adverse selection. It follows that, as price is lowered and participation is increased, there is less likelihood that the newer participants are as high a risk as the earlier self-selecting (at higher prices) participants.

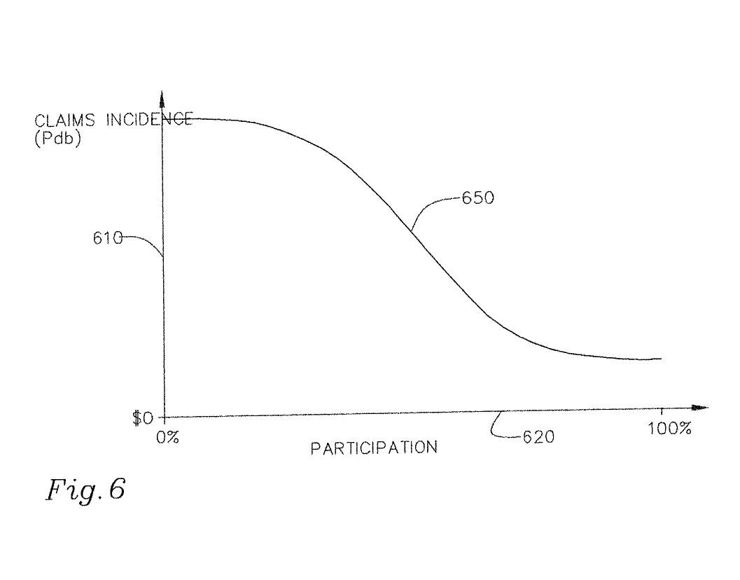

The impact of increased enrollment is illustrated in FIG. 6, which represents the claims incidence or Pdb 610 for a given year (i) correlated 650 to the percentage of eligible employees participating 620 in the simplified issue plan. As can be seen, the higher the participation, the lower the claims incidence or Pdb. This function is naturally highly dependent on adverse selection as depicted in FIG. 4. Adverse Selection will have a diminishing impact on claims incidence as participation nears 100%, as depicted by the flattening to the far right of the curve 650. According to the invention, an increase enrollment action is especially favorable when participation correlates to a point where there is a steep gradient of Pdb.

The models presented above explain a part of the method according to the invention. By increasing the percentage of participants relative to the eligible population, positive results are produced. According to the object of the invention, increasing the percentage of participants relative to the eligible population, which should decrease the claims incidence or Pdb, and should therefore also decrease the average price charged to participants, it can be expected, according to the demand curve, that a further increase in enrollment will result. This positive cycle is accomplished through the increase enrollment action described in the invention.

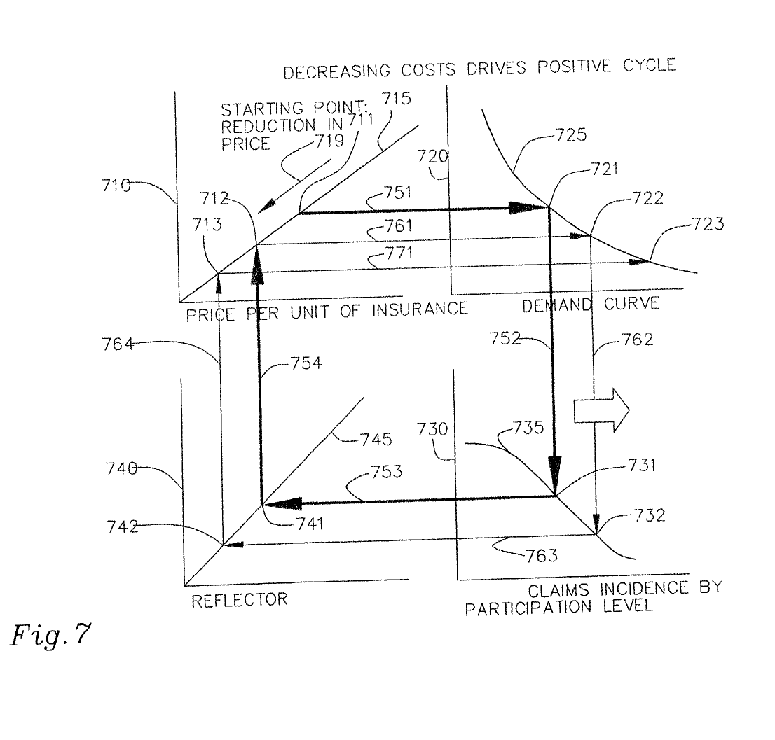

FIG. 7 illustrates a process whereby the increase enrollment action drives down Pdb, which in turn drives down the average price 719, which results in an increased demand, which can be addressed by initiating a new increase enrollment action. With this, the positive experience spiral is rolling according to FIG. 7. FIG. 7 is depicted as a spiral being deflected by four different functions 715, 725, 735, 745, each in its own graph 710, 720, 730, 740. In an upper left quadrant a price per unit of insurance graph 710 is used as a starting point with a first price 711. This price is transported 751 to a demand curve graph 720 in the upper right quadrant. The first price 711 will hit the demand curve 725 to give a first demand 721. The first demand 721 is then transported 752 to a claims incidence by participation level graph 730 in a lower right quadrant. The first participation 721 will give a first incidence 731 on the incidence by participation level curve 735. The first incidence 731 is transported 753 to a reflector graph 740 in a lower left quadrant. The reflector graph 740 with its reflector function 745, will transform the first incidence 731 to a second price 741, which is then transferred 754 to a second price 712 on the price graph 710. This second price 712 will transport 761 and give a second demand 722, which in turn is transported 762 to give a second incidence 732. The second incidence 732 is then transported 753 via a third price 742 to the third price 713 on the price graph, which in turn will transport 771 to a third participation 723 and so on. In other words, a lowering of the price will increase demand, which in turn will increase participation, which in turn will lower claims incidence, which in turn will lower the price per unit of insurance, and so on. Thus, a positive cycle is continued.

A communication module may be utilized within the increase enrollment action. After analyzing data to target pockets of low participation and addressing this weak participation with either a participant price reduction or benefit enhancement, customized communication pieces, enrollment forms and enrollment processes are employed to effectively communicate the participant price reduction or enhanced benefit. The communication pieces are generated using a proprietary plan management software, which is part of this invention, to communicate directly to each eligible plan member their eligible benefit levels and their corresponding costs. The software generates each enrollment kit preprinted and in order by eligible plan member. Each eligible plan member is provided their information in a particular order, sometimes over several communication pieces spanning several weeks. The required enrollment forms are prepopulated with each eligible plan member's particular data and arranged in a way that allows them to easily enroll in the benefit and complete their required paperwork. In addition, forms are included that allow eligible plan members who have portable benefits to continue payments of these portable benefits automatically upon termination from the plan.

It is noted that the plan management software includes a database that keeps track of each eligible plan member's data, including contact information, plan enrollment status, notes, etc. It also keeps track of enrollment history and benefit mixes (between variable price and fixed price insurance). It generates communication pieces such as those mentioned above, and enables billing reconciliation between the plan income (generally payroll deductions and/or plan sponsor contributions) and plan expenses (premiums for variable priced and/or fixed price insurance). It also allows case administrators to answer questions from the eligible population, their benefits department, and insurance carriers. It can support local area network access and third-party direct access via the Internet. It has customized data interfaces to import and export data between it and plan sponsors, insurance carriers, and other administrators. It may also be used as the data management platform from which data can be analyzed to determine appropriate positive cycle actions to be taken.

Returning to FIG. 7, the positive cycle outlined in this figure should decrease the average price of insurance per unit of benefit. Whether the total cost of the insurance plan will increase or decrease upon an average price per unit decrease is dependent upon the shape of the demand curve. A part of the analysis according to the invention is to take into account the potential impact of a decrease participant price action or a segment participant price action on the demand curve when determining whether or not to implement an increase enrollment action. However, it is clear that the positive cycle will lower the average price per unit of the variable priced insurance benefit. This leads to another positive cycle action according to the invention.

Upon a reduction in the cost of the variable priced insurance, an alternative to implementing a decrease participant price action or a segment participant price action exists. This alternative is referred to as a shift risk action according to the invention. It is possible to apply the shift risk action in conjunction with, or totally independent of, an increase enrollment action. The shift risk action could initiate or propagate a positive cycle on its own even if it is directly financed from within the plan and not accompanied by an increase in enrollment. The shift risk action has the objective and result of decreasing the average compensation (XA) and the standard deviation (SIGA) thereof as it relates to the variable priced insurance, which should decrease the average unit price of the variable priced insurance as discussed above. The reason for the reduction in XA and SIGA is due to the fact that a portion, and in some cases all, of the variable priced insurance risk for a segment of the population is transferred to fixed price insurance policies. The resulting decreases in XA and SIGA for the compensation covered by variable priced insurance will decrease the potential claim volatility and, therefore, the required SecPx related to volatility risk, without reducing the total coverage for any individual participant.

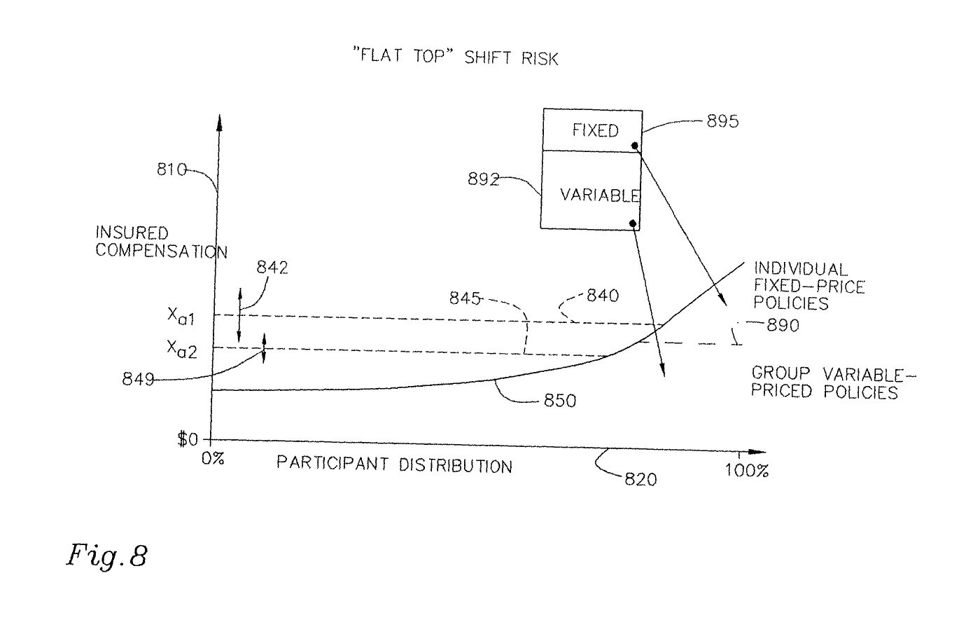

FIG. 8 illustrates the shift risk action in a compensation 810 versus participant distribution 820 graph where the curve 850 indicates that a small segment of the participating population is highly compensated. In this example, all the variable priced insurance covering compensation above a specific level 890 is replaced by fixed price insurance policies 895 for a specific segment of the population having compensation above the specific level 890. The XA1 840 will then decrease to XA2 845 and the standard deviation will decrease from SIGA1 842 to SIGA2 849 for the remaining variable priced insurance 892. This is referred to as flat top shift risk action.

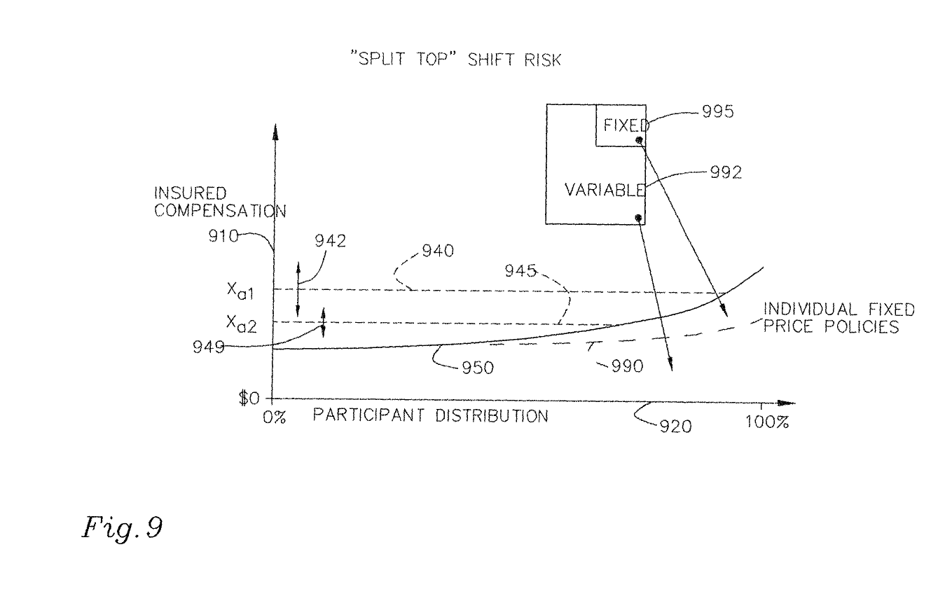

Another example is to apply the split top shift risk action illustrated by FIG. 9, in which a percentage of the variable priced insurance covering compensation above a specific level is replaced by fixed price insurance 995. A split top shift risk action is also effective in decreasing the average compensation from XA1 940 to XA2 945 and its standard deviation from SIGA1 942 to SIGA2 949.

Many other combinations of variable priced insurance and fixed price insurance may be applied under the shift risk action depending on the shape of the employee compensation distribution curve or other underlying factors that may impact the resulting unit and total costs for variable priced insurance and the fixed price insurance. As will be exemplified later, it is important to properly balance the increased amount and unit costs of the fixed price insurance with the decreased amount and unit costs of the variable priced insurance. As long as the total cost of the fixed price insurance acquired under a shift risk action is lower than the resulting overall decrease in total cost of the variable priced insurance, an opportunity will exist to either:

Apply an increase enrollment action using a decrease participant price action;

Apply an increase enrollment action using a segment participant price action;

Finance an additional shift risk action;

Apply an enhance benefit action (enhancing the terms of the plans benefits);

Apply a premium reserve action (reserving premiums in the name of the plan in order to fund future positive cycle benefits);

Apply an increase benefit action (increasing the maximum benefit levels of the plan);

Apply any other positive cycle actions that may be appropriate under the circumstances; or

Apply a combination of any one or more of the above.

The chosen positive cycle action or combination of positive cycle actions may be influenced by the sponsoring entity's overall benefit strategy. Elements of this strategy could include:

Desire to keep the average cost per insured constant when applying a shift risk action;

Willingness to increase the premium charged to a segment of the participants when applying a shift risk action based on the enhancement of benefit value provided by the fixed price insurance; or

Desire to reduce the average cost per insured when applying a shift risk action.

When a shift risk action is applied and the average compensation level covered by variable priced insurance is reduced from XA1 to XA2 and the resulting standard deviation is reduced from SIGA1 to SIGA2, then it follows that the average price per insured for variable priced insurance within the plan can be lowered as follows:

DeltaPrice(average)(riskprem)(i)/insured=(1+3rdPrtyCost)*(ReplRatio)*Pdb(i)*(XA1 *SecPx1-XA2*SecPx2)

The resulting aggregate price reduction may be used to finance the fixed price insurance that is acquired to cover compensation no longer insured by variable priced insurance. This financing is required since the fixed price insurance is generally more expensive on a unit basis than the variable priced insurance. As a result, in most cases, if the shift risk action is applied without an offsetting price reduction in the variable priced insurance, then:

Participant premiums must be increased;

The plan sponsor's plan contributions, if any, must be increased; and/or

The insurance benefits for the group must be reduced.

The size of the cost difference, if any, between the variable priced insurance and fixed price insurance will depend upon the characteristics of the individuals within the group to which the shift risk action is applied. A shift risk action becomes less effective when the slope of Pdb flattens. Therefore, in most circumstances, one or more of the following steps should be taken, according to the invention, in order to focus the shift risk action most effectively:

A: Use the aggregate price reduction in the variable priced insurance to fully finance an amount of fixed price insurance that replaces an entire segment of the eliminated variable priced insurance. Therefore, the total insurance benefit is maintained.

B: Use the aggregate price reduction in the variable priced insurance to finance an amount of fixed price insurance that replaces only a portion of the variable priced insurance eliminated. Therefore, the total insurance benefit is reduced.

C: Use the aggregate price reduction in the variable priced insurance along with an increase in premiums charged to participants to fully finance an amount of fixed price insurance that replaces an entire segment of the variable priced insurance eliminated. Therefore, the total insurance benefit is maintained.

D: Use the aggregate price reduction in the variable priced insurance along with an increase in plan sponsor contributions to fully finance an amount of fixed price insurance that replaces an entire segment of the variable priced insurance eliminated. Therefore, the total insurance benefit is maintained.

E: Use the aggregate price reduction in the variable priced insurance to lower participant premiums in conjunction with an increase enrollment action with the expectation of increasing participation per FIG. 7.

F: A combination of the steps A and E, B and E, or C and E wherein the aggregate price reduction is used to both finance fixed price insurance and lower participant premiums in conjunction with an increase enrollment action with the expectation of increasing participation per FIG. 7.

The options E and F entail, according to the invention, an expectation that participation will increase. Therefore, the invention contemplates a reduction in the Pdb. A Pdb reduction could be used to finance either a further shift risk action, a decrease participant price action, or a segment participant price action. Any one of these positive cycle actions should result in additional unit price reductions in the variable priced insurance, which could in turn enable an additional shift risk action. A very important result of the increase enrollment action is that the increased number of participants creates a broader base over which to finance the shift risk action(s).

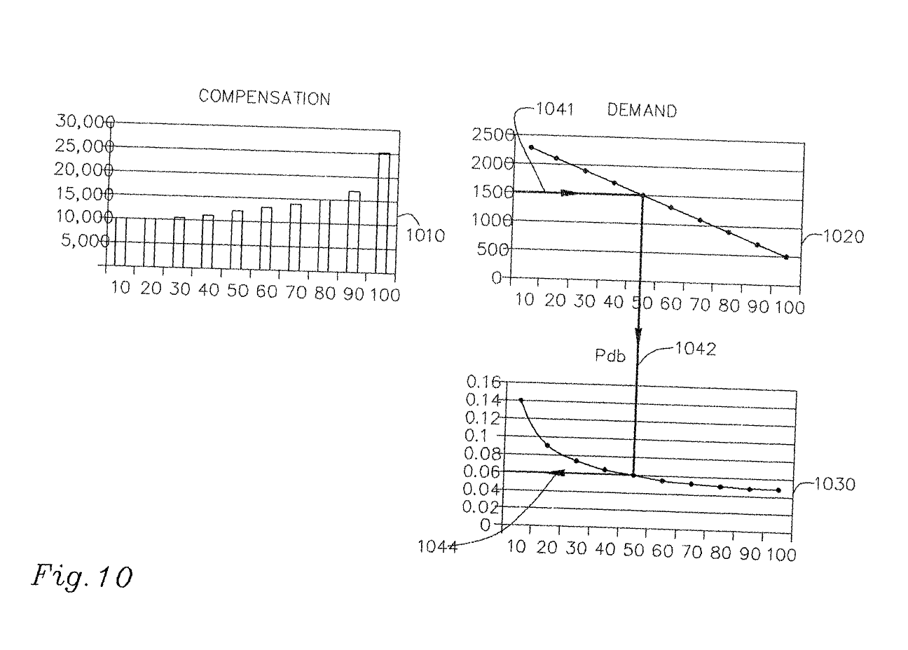

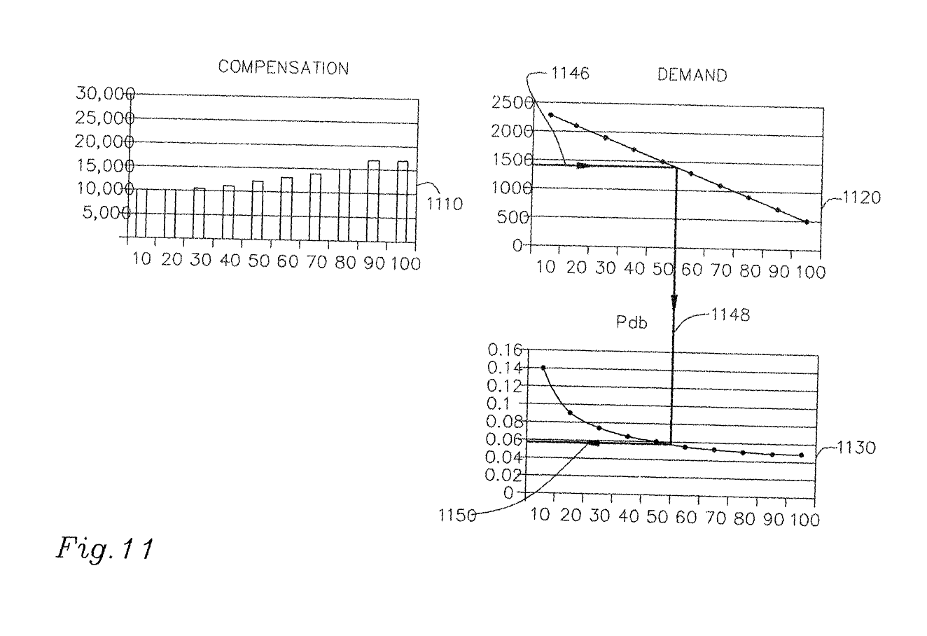

FIGS. 10 and 11 illustrate the relationship between a shift risk action and other components of the invention. There is the compensation distribution function 1010, 1110, demand curve 1020, 1120 (which could be derived from a combination of analysis of the eligible population, correlated factors, potentially from both within and outside the plan, and/or past experience), and the assumed probability of disability, or Pdb, curve 1030, 1130 for the eligible population.

FIG. 10 illustrates the results prior to implementing the shift risk action. In the current compensation distribution 1010, there is an average compensation, or XA, of $13,750 per month and a standard deviation thereof, or SIGA, of $4,578. This will lead to an average benefit cost per participant of $1,500. According to the demand curve 1020, this should result in 1041 a participation level of 50%. A participation level of 50% when transferred 1042 to the Pdb curve 1030 will result in 1044 a Pdb of 0.06, from which the average benefit cost per participant of $1,500 is derived.

FIG. 11 illustrates the effect of implementing a shift risk action by replacing variable priced insurance with fixed price insurance to cover participants'monthly compensation above $17,000. Both XA and SIGA covered by variable priced insurance are reduced, which should result in a lower unit cost for the variable priced insurance. In this case, according to the demand curve and the Pdb curve, this results in a reduction in the average underlying participant benefit cost for the variable priced insurance of $280 per participant. The lower underlying unit cost for the variable priced insurance is then utilized to finance fixed price insurance. In this case, it is assumed that the fixed price insurance is twice as expensive as the variable priced insurance. The average benefit cost for participants whose monthly compensation exceeds $17,000 is $1,787. The plan will utilize a portion of the $280 savings resulting from the unit cost reduction in the variable priced insurance to finance the increase in average benefit costs for participants with monthly compensation over $17,000.

In the example illustrated above, the financing is accomplished and $101 of the $280 gross savings per participant remains unused. The remaining savings may then be used to apply a reduce participant price action or a segment participant price action, whereby the average total benefit cost to participants is reduced to $1,400. Utilizing an increase enrollment action, this should result in 1146 an increase in the participation level to 55% of the total eligible population. The 55% participation is then transferred 1148 to the Pdb curve 1130, which in turn reduces the Pdb to 0.058182. The reduced Pdb should decrease the variable priced insurance cost even further, which may enable the application of a further shift risk action and/or a decrease participant price action or a segment participant price action with the expectation of leading to an additional increase enrollment action. A positive cycle is therefore accomplished.

Based on the example above, the plan manager may consider a further shift risk action whereby fixed price insurance is used to replace variable priced insurance covering all compensation over $15,000. If this shift risk action were to be applied, the total compensation covered by variable priced insurance would be further reduced from $17,000 to $15,000. However, the resulting reduction in the unit cost of the underlying variable priced insurance would not be sufficient to finance the increased average benefit cost resulting from the additional fixed price insurance. This is because, based on the data analysis that is performed in accordance with the present invention (as detailed herein), the reduction in XA and SIGA does not result in a sufficient reduction in the underlying unit cost in the variable priced insurance. Assuming the plan manager does not want to diminish the overall benefit, raise participant premiums, and/or increase plan sponsor contributions, the data analysis indicates that an additional shift risk action cannot be applied at this time.

Given a typical compensation distribution, it can be stated that as each incremental unit of shift risk action is applied, the effect on XA and SIGA decreases relative to the last unit of shift risk action. Further, as each incremental shift risk unit is applied: a) the number of participants whose variable priced insurance is transferred, in whole or in part, to fixed price insurance increases and/or b) the amount of variable priced insurance transferred to fixed price insurance increases. The diminishing impact on XA and SIGA combined with the increasing requirement for financing fixed price insurance makes it more and more difficult to apply a shift risk action that will continue the positive cycle. In other words, the current shift risk action is likely to have a greater impact than subsequent shift risk actions. Therefore, in one embodiment, this invention includes a careful analysis, which should be performed before applying the shift risk action.

The detailed description above explains the theory and several of the elements of the positive cycle actions covered by the invention, including an increase enrollment action, a shift risk action, a decrease participant price action, a segment participant price action, a reduce adverse selection action, a portability action, a reduce group claims volatility action, and a request for proposal action. These, along with other actions according to the invention, have the objective of creating and/or furthering positive plan experience, herein referred to as the “positive cycle”.

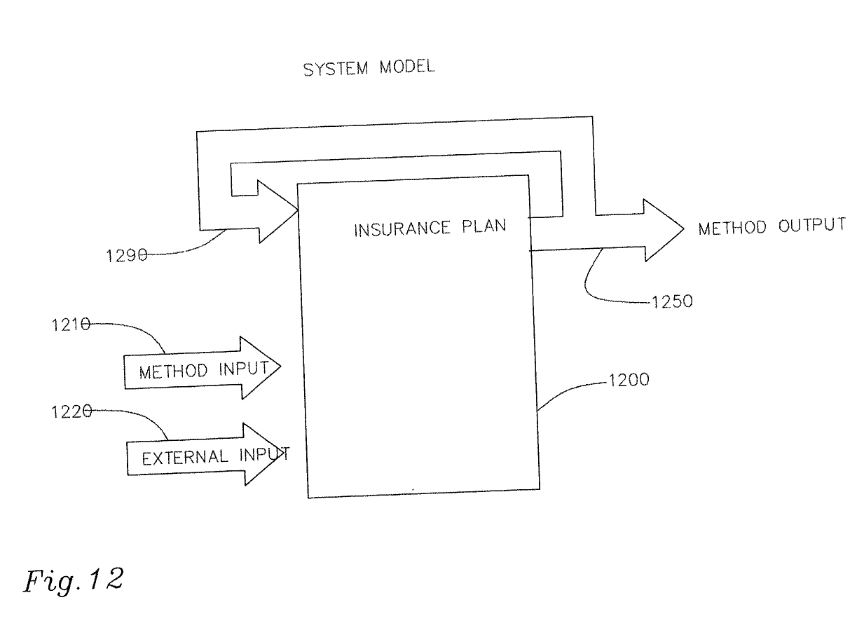

The overall process of implementing each positive cycle action according to an embodiment of the invention may be described by way of a system model, as illustrated in FIG. 12. Typically, a simplified issue plan 1200 already exists when the invention is applied. However, the invention works equally well if applied to a new plan prior to implementation or when creating an integrated plan after two entities sponsoring different insurance plans have merged. The method input 1210 includes a positive cycle action or actions according to the invention. The method input 1210 will create an impact on the simplified issue plan 1200. The impact may be, after some period of time depending on the type of input, analyzed and/or measured as the method output 1250. The method output 1250 may also affect the future results of the insurance plan through a feedback loop 1290. External input 1220 that could include market trends, regulatory changes, economic factors and/or carrier behavior may amplify, attenuate, emphasize, and/or limit the possible method input according to the invention within the plan.

There are also limitations on the possible method input 1210 that may be applied to a simplified issue plan that must be taken into account. Several of the methods described within the invention may have an implementation cost. In daily business life, resources are often limited. This may influence the method input 1210 that is chosen and the period of time over which the method output 1250 is measured. In certain circumstances, a sub-optimal method input may be chosen since it reflects the best available insurance risk, price, and/or enrollment optimizing method input given other constraints. The plan 1200 will produce method output 1250 that may be utilized when analyzing the plan in order to determine potential positive cycle actions. The plan manager may elect to apply the chosen positive cycle action(s) in several phases even if the analysis of the plan indicates that greater results might be achieved in a single step through the simultaneous application of two or more positive cycle actions. The phasing strategy becomes even more important when the positive cycle actions are initiated before a credible analysis of the plan can be performed. Also, since the insurance plan may contain, or be affected by, elements that can result in non-linear responses to method input, applying the method in several phases lowers the overall risk that the plan produces undesired method output.

According to the invention, a simplified issue plan is analyzed and characterized before a method input is applied. This may include an analysis of the present state of the insurance plan, method input, external input, and method output, and may further comprise an analysis of past behavior, including the state of the insurance plan, method input, external input, and method output, and may further comprise an analysis or simulations of future behavior regarding the state of the insurance plan, method input, external input, and method output. It must be understood that in daily business life, the scope of the data analysis may be affected by resource limitations. Therefore, it may be necessary to utilize judgment in determining the scope of data analysis that is practical in determining one or more appropriate method inputs or positive cycle actions to apply. There are a vast number of computer-aided tools available for performing data analysis. In order to improve the method, further past experience of the impacts of different applied methods and population characteristics may be imported and/or shared between different populations. Further, correlated factors not related to the plan itself may be imported and analyzed if they are deemed to have predictive value given certain inputs. These additional data factors are described in the general art as databases containing additional data that may be deployed for facilitating the analysis.

As a summary, an objective of the invention is to optimize the performance of simplified issue plans with respect to one or more of the following objects:

Reduce adverse selection risk;

Reduce volatility risk;

Reduce unit cost(s) of the plan;

Increase profitability for insurance provider(s) and/or plan administrator(s);

Increase the benefit value delivered to plan participants.

The theoretical models and tools that have been described within the instant application help to optimize a simplified issue plan according to the invention. They provide guidelines as to how the different elements relating to the very complex environment of insurance plans can be managed most effectively when optimizing an insurance plan. It should be understood, however, that the models and tools described, while indicating particular embodiments of the invention, are given by way of illustration only, and various modifications may naturally be performed without deviating from the spirit of the present invention.

There are numerous principles of designing a simplified issue plan that should typically be observed in order to optimize the plan's experience over time. They include the methods described in detail above, as well as the following:

Avoid over-insurance resulting from excessively rich benefit formulas;

Avoid over-insurance resulting from non-plan coverage acquired independently by the individual participant;

Avoid adverse selection resulting from high-risk combo options that give unhealthy participants the option of electing benefit levels that are materially higher than the benefit levels healthy participants may elect;

Avoid undesirable participation levels and/or adverse selection resulting from pricing to participants that encourages undesirable participation amongst different population segments;

Avoid undesirable participation levels and/or adverse selection resulting from complicated plans that are difficult to communicate;

Achieve desired participation levels and reduce adverse selection by using tailored communications with each eligible individual that detail their specific costs and benefits under the plan;

Reduce volatility of claim costs covered by variable priced insurance by reducing the standard deviation of average benefits per participant covered by variable priced insurance.

Avoid overpaying insurance carriers by properly administering a request for proposal;

Reduce claim costs by allowing an insurance carrier to administer short-term disability claims for better long-term disability claim results.

Increase the ability of the plan sponsor to implement and administer the above methodologies by utilizing the services of a qualified third party administrator.

In addition, the invention may be practiced using the following specialized tools which allow analysis, determination, implementation, and/or evaluation (among others) of the positive cycle actions:

Data import model—Translates raw data from the sponsor, or its representative, relevant to its current plan and eligible members into a computer program that can be accessed by the tool blocks described below;

Claims analyzer—Reviews, segments, and summarizes the current plan claims experience so that optimizing opportunities, according to this invention, can be accurately identified;

Participation analyzer—Segments the population of participants and non-participants and identifies participation weakness that may be affecting plan results;

Pricing analyzer—Correlates claims experience to current pricing;

Participant pricing analyzer—Correlates segmented claims experience to segmented participant pricing to correlate employee cost to employee price;

Integrated plan pricing module—A tool that enables a plan manager to appropriately set participant pricing that will pay for both the variable priced insurance and the fixed price insurance that is present after a shift risk action has been applied.

Claims volatility risk synthesizer—Quantifies the current plan's potential volatility in claims experience based on potential claims incidence variance—seeking to identify potential risk exposure that might be reduced using methods according to the invention;

Plan design analyzer—Uses tools according to the invention to quantify the expected results of potential plan design alternatives;

R/P evaluator—A tool that measures the risk adjusted premium of various plan design alternatives;

RFP (request for proposal) process—A unique method of packaging plan and participant data for carrier review in order to maximize their general understanding of the plan, its eligible and participating population, and its risks with the ultimate goal of minimizing insurance carrier rates;

Implementation processes—Minimizes the impact to the sponsor and the eligible population of enhancing carrier and plan design;

Facilitated enrollment process—Utilizes a proprietary plan management database to produce tailored enrollment communications that are delivered to each eligible member of a targeted segment of the eligible population making it easy and efficient to both understand the offer and enroll in the benefit;

Fulfillment outsource—Print and production capability, originating from the proprietary plan management database, of the various components of the facilitated enrollment process;

Administration process—Utilizes a proprietary plan management database to keep track of plan additions, terminations, changes, claims, and cost allocations, as well as answer member questions and perform ongoing experience monitoring. By separating the administration processes from the insurance carrier, the ability to easily switch insurance carriers, through the RFP process, is enhanced and therefore, the leverage over the carrier to maintain appropriate pricing is enhanced;

Premium billing module—Creates a cash flow report of all plan revenue (from the sponsor and/or participants) and expenses (administration, claim costs and/or premiums);

Shift risk analyzer—a tool that allows the impact of employing the shift risk action on potential plan results to be simulated;

Past experience import module and simulator—a tool that allows the impact of past experience on potential plan results to be simulated;

Correlated data elements import module and simulator—a tool that allows the impact of correlated data elements on potential plan results to be simulated.

One application of this invention is exemplified through the following narrative: An Employer engages a consultant to review the disability plan they currently offer their 40,000 employees. The consultant has full use of the invention described herein. The current plan sponsored by the employer, which is a simplified issue plan, has a core benefit, which is entirely paid for by the employer and insures 40% of every employee's base salary up to $5,000 per month or $60,000 per year. This core benefit is insured by variable priced insurance. In addition, the plan offers employees the option of a voluntary buy-up benefit that insures an additional 30% of their total earnings (including base salary and bonus) from $0 to $50,000 and 70% of all total earnings above $50,000 with no maximum limit. This brings the total disability benefit up to 70% of total earnings for all employees electing the buy-up plan. The cost for the buy-up benefit is $0.70 per $100 of covered compensation and is the same for all employees regardless of title, age, or earnings.

The consultant performs an analysis of the current plan's claims experience and current participation. The results show that the claims experience amongst participants in the core benefit is in-line with average disability incidence based on surveys within the employer's industry. However, the claims experience in the buy-up benefit shows a significantly above average incidence of claim. This could be indicative of adverse selection. Overall participation in the core benefit is 100% since it is employer paid; overall participation in the buy-up benefit overall is 35%. When the participation in the buy-up benefit is segmented by earnings, the participation is shown to be under 10% amongst employees earning under $50,000; 30% amongst those earning between $50,000 and $150,000; and 50% amongst those earning over $150,000. It is determined that the employer cost for the core benefit is $5 million per year. This translates into an underlying rate of $0.40 per $100 of covered compensation being charged by the variable priced insurance carrier for the core benefit. This rate, combined with the $0.70 per $100 of covered compensation being charged for the buy-up benefit results in a blended rate of $0.55 being charged by the insurance carrier for all coverage.

The employer, based on advice from the consultant developed using tools embodied by the invention, redesigns their plan. The new plan design compares to the original as follows:

| | New Plan | Original Plan |
|---|---|---|
| Replacement Ratio | 60% | 40% or 70% |
| Buy-up Option | None | Yes |
| Element of High Risk Combo | No | Yes |
| Insurance Carrier(s) | Yes (Variable Priced) | Yes (Variable Priced only) |
| Maximum Benefit | $25,000 / month | None |
| Covered Earnings | Base Salary and Bonus | Base Salary only for Core |
| | | Benefit |
| | | Base Salary and Bonus for |
| | | Buy-up Benefit |
| Participant Pricing (cost per | $0.00 for Employees earning | $0.00 for Core Benefit |
| $100 of covered earnings) | under $50,000 | $0.70 for Buy-up Benefit |
| | $0.35 for Employees earning | |
| | $50,000 to $150,000 | |
| | $0.70 for Employees earning | |
| | over $150,000 | |
| Total Employer Cost | $5,000,000 / year | $5,000,000 / year |
| Insurance Carrier Underlying | $0.40 | $0.55 |
| Rate (all coverage) | | |

The key changes include unifying the plan so that all employees have only one choice: In or out of the plan. The plan focuses the employer contribution primarily towards employees earning under $50,000 by offering them a free benefit. Employees earning under $50,000 may not be willing to afford a discretionary benefit like insurance unless they see the risk as particularly high and urgent. This was evidenced in the low participation and high claims amongst this group in the original buy-up benefit. While the free benefit was eliminated for all employees earning over $50,000, pricing was segmented after studying demand in a way that anticipates high participation results. The plan is further simplified by offering only one replacement ratio and by covering base and bonus earnings. An additional savings is realized by capping the maximum benefit at $25,000 per month that in turn reduces projected volatility and its corresponding volatility risk premium that is charged by the variable priced insurance carrier.

Based on the above changes, the consultant utilizes the request for proposal action and its component methods to create an auction environment amongst potential insurance carriers for the right to be engaged to insure this plan. Clear plan design specifications, participation data and expectations, claims history, and enrollment strategy are presented to each carrier. The result is the overall plan is insured for $0.15 less than it was previously. A significant portion of this savings is attributed to the consultant's ability to employ the increase enrollment action within the invention, which presents the simplified plan design to all eligible employees through an easy-to-understand, tailored communication that makes it simple for the employee to decide and participate. The result is that the insurance carrier will be subject to less adverse selection risk.

After the new plan is implemented, the participation results are 100% for those earning under $50,000 (which is a given, since their benefit is 100% employer paid) and 75% for those earning over $50,000. This is higher than anticipated and indeed results in lower adverse selection and a lower incidence of claims. After 12 months, the plan experience is analyzed. The variable priced insurance carrier is also presented with a plan design alternative that offers everyone fixed price insurance from another carrier for the portion of his or her benefit that exceeds $15,000 per month. This is the shift risk action as described above and has the effect of reducing potential claims volatility for the variable priced insurance carrier. As a result of the already realized lower claim costs and the reduced potential volatility risk, the variable priced insurance carrier reduces its rate to $0.35. This reduction in underlying cost allows the plan to afford the fixed price insurance for benefits above $15,000 without increasing the employees' or employer's costs and is implemented immediately. In addition, the employer announces good news to all employees earning over $300,000 (the amount needed to qualify for more than $15,000 of monthly benefit) that their benefit now is partially portable since it is covered by an individual policy. Studies have consistently shown that employees—particularly those highly compensated—value portability in their benefits. This type of plan requires the consultant to utilize the proprietary plan management database and administration system that is part of this invention to keep track of the benefit mixes, payroll deduction amounts, and premiums due to the carriers on behalf of each employee.

After another 12 months, the plan is reviewed again. The experience is better than expected, and the variable priced insurance carrier offers another price reduction to $0.30. The consultant advises the employer to capture the savings in a premium reserve fund that can be utilized on behalf of the plan in the future. Alternatives would be to implement a decrease participant price action, a segment participant price action, both of which could be followed by an increase enrollment action, and/or to implement an additional shift risk action. Instead, the plan develops a surplus cash reserve that will eventually be used for the benefit of plan participants.

Another 12 months pass and environmental factors that include an economic downturn that hits the employer's industry particularly hard are experienced. The employer's financial results are down, and as a result, compensation, including bonuses, are generally reduced, and layoffs are occurring. This has created a significant increase in disability claim costs. The variable priced insurance carrier raises its rate to $0.40. The result to the employer and the participants is substantially less harsh than it would have been had the invention's methods not been utilized. Much of the benefit is now insured with fixed price insurance that is guaranteed not to change based on the plan's experience. Further, the increased claim costs are felt less by the variable priced insurance carrier than they would have been since their benefit maximum is now $15,000 instead of $25,000. Finally, the surplus that has been built up in the plan can be used to fully or partially offset the increased insurance cost.

It is clear that the invention has had a beneficial impact on all the parties described above, including the employer, the employees, the variable priced insurance carrier, and the fixed price insurance carrier.

The invention can be implemented, either completely or in part, through the use of a computer system. The method according to the invention can be fully implemented in a computer system or be more or less manually controlled. The invention is not limited to the embodiments described above but may be varied within the scope of the appended patent claims.

What is claimed is:

1. A method of optimizing a performance of a simplified issue insurance plan with respect to an eligible population of potential insureds, the method comprising:
(a) analyzing the eligible population in view of at least one characteristic of said population in relation to the simplified issue plan;
(b) based on the analysis, determining at least one positive cycle action to be applied with respect to said eligible population; and
(c) implementing the at least one positive cycle action.

2. The method of claim 1, wherein said simplified issue insurance plan is a disability insurance plan.

3. The method of claim 1, further comprising evaluating an impact of the at least one implemented positive cycle action.

4. The method of claim 1, wherein step (a) further comprises analyzing the eligible population in view of at least one characteristic of said population in relation to the participants of the simplified issue plan.

5. The method of claim 1, wherein step (b) further comprises determining at least one parameter of at least one determined positive cycle action.

6. The method of claim 1, wherein the at least one characteristic of the eligible population is a characteristic that impacts overall plan performance.

7. The method of claim 1, wherein the simplified issue plan includes variable priced insurance.

8. The method of claim 1, wherein the positive cycle action is an action whereby enrollment in the plan is increased.

9. The method according to any one of claims 1-8, wherein the positive cycle action is a shift risk action, whereby the simplified issue plan is modified to include an element of fixed price insurance such that at least some participants of the plan are at least partly insured with the fixed price insurance in accordance with the shift risk action.

10. The method of claim 9, wherein the simplified issue plan is modified to include an additional element of fixed price insurance such that said at least some participants of the plan receive an increased portion of their benefit through said additional fixed price insurance in accordance with the shift risk action.

11. The method of claim 9, wherein the simplified issue plan is modified to include an element of fixed price insurance such that selected participants who meet specified criteria are at least partly insured with the fixed price insurance in accordance with the shift risk action.

12. The method of claim 9, wherein the simplified issue plan is modified to include an additional element of fixed price insurance such that selected participants who meet specified criteria receive an increased portion of their benefit through said additional fixed price insurance in accordance with the shift risk action.

13. The method of claim 8, wherein the positive cycle action is an increase enrollment action.

14. The method of claim 13, wherein the increase enrollment action is targeted to at least one group of individuals from the eligible population based on the step of analyzing said population.

15. The method of claim 13, wherein the increase enrollment action utilizes a communication module in such a way as to produce customized communication materials describing specific plan costs and benefits unique to each one of said eligible individuals.

16. The method according to claim 13 or 15, wherein the increase enrollment action utilizes a communication module in such a way as to produce prepopulated forms with an eligible individual's data, thereby increasing ease of enrollment.

17. The method according to claim 15, wherein the communications module is contained within a plan management database.

18. The method of claim 14, wherein the at least one group is selected in such a way as to reduce adverse selection.

19. The method of claim 14, wherein the step of analyzing the population comprises analyzing the eligible population in view of the average probability that a plan participant will become disabled (Pdb).

20. The method of claim 14, wherein the step of analyzing the population comprises analyzing the eligible population in view of one or more factors selected from the group consisting of: work location, home location, gender, coverage/plan options, job description, business unit or division, price, title, previous or current method of communication, age, compensation, employer contribution level, tax-status, benefit formula, benefit maximum, various risk characteristics, smoker status, tenure, correlation of participation characteristics of other plans within the group, and correlation with behavior characteristics not related to the group.

21. The method of claim 14, wherein the increase enrollment action comprises generating promotional information adapted to at least one group of individuals from the eligible population.

22. The method of claim 8, wherein the positive cycle action is a decrease participant price action.

23. The method of claim 8, wherein the positive cycle action is a segment participant price action.

24. The method of claim 1, wherein the at least one characteristic of the eligible population is selected from the group consisting of: compensation, percentages of eligible population in different salary brackets, SIC codes, age of eligible population, job description, sex, smoker status, location of work, location of home, and combinations thereof

25. A method according to any one of claims 1-3, further comprising:
(a) upon implementation and subsequent evaluation of an impact of said at least one positive cycle action, determining an additional positive cycle action to be applied with respect to said eligible population; and
(b) implementing said additional positive cycle action.

26. The method of claim 25, wherein said additional positive cycle action is a request for proposal action.

27. The method of claim 25, wherein said additional positive cycle action is an action that creates an increased enrollment in the plan.

28. The method of claim 25, wherein the additional positive cycle action is a shift risk action.

29. The method of claim 25, wherein the additional positive cycle action is an increase enrollment action.

30. The method of claim 25, wherein the additional positive cycle action is a decrease participant price action.

31. The method of claim 25, wherein the additional positive cycle action is a segment participant price action.

32. The method of claim 25, further comprising importing past experience of a population selected from the group consisting of: the eligible population being analyzed, a similar population, and a combination thereof, wherein the step of determining at least one positive cycle action based on the analysis further comprises taking into account said imported past experience.

33. The method of claim 1, further comprising importing past experience of a population selected from the group consisting of: the eligible population being analyzed, a similar population, and a combination thereof, wherein the step of determining at least one positive cycle action based on the analysis further comprises taking into account said imported past experience.

34. A method of optimizing a performance of a simplified issue insurance plan with respect to an eligible population of potential insureds, the method comprising:
(a) analyzing the eligible population in view of at least one characteristic of said population in relation to the participants of the simplified issue plan;
(b) based on the analysis, determining at least one positive cycle action to be applied with respect to said participants of said population;
(c) implementing the at least one positive cycle action; and
(d) evaluating an impact of the at least one implemented positive cycle action.

35. The method of claim 34, wherein said simplified issue insurance plan is a disability insurance plan.

36. A system arranged to optimize a performance of a simplified issue insurance plan with respect to an eligible population of potential insureds, wherein the system comprises:
(a) means arranged to analyze the eligible population in view of at least one characteristic of said population in relation to the participants of the simplified issue plan;
(b) means arranged to determine a positive cycle action based on the analysis;
(c) means arranged to implement the determined positive cycle action; and
(d) means arranged to evaluate an impact of the implemented positive cycle action.

37. The system of claim 36, wherein said simplified issue insurance plan is a disability insurance plan.
